(19) United States
(12) Patent Application Publication
(10) Pub. No.: US 2025/0082110 A1
(43) Pub. Date: Mar. 13, 2025

(54) Quick-Assembly Bed Base

(71) Applicant: ITABOX INDÚSTRIA E COMÉRCIO DE MÓVEIS DE MADEIRA LTDA., Itapetininga (BR)

(72) Inventor: Hederson Camargo Mantovani, São Paulo (BR)

(21) Appl. No.: 18/954,766

(22) Filed: Nov. 21, 2024

Related U.S. Application Data
(63) Continuation of application No. 18/277,849, filed on Aug. 18, 2023.

(30) Foreign Application Priority Data
May 17, 2021 (BR) BR2020210095623

(51) Int. Cl. A47C 23/06; A47C 19/02

(52) U.S. Cl. CPC A47C 23/066; A47C 19/025

(57) ABSTRACT

Provided is a quick assembly sommier box including end panels that have couplings on the inside and at opposite ends; and side panels that have couplings on the inside and at opposite ends. The upper face of each side panel has a step shape in the lower plane of which a Velcro strip is fixed. The couplings are defined by plates from which spaced apart eyelets project, which are able to receive a pin destined to penetrate all the central holes of the eyelets, with such pin being held in position by means of a cotter pin. The sommier box also includes bipartite bed frames, each composed of equidistant slats joined by Velcro strips. The sommier box defined in this way can be assembled extremely quickly and without the need for tools.

### CROSS REFERENCE TO RELATED APPLICATIONS

This application is a continuation of U.S. patent application Ser. No. 18/277,849 filed Dec. 3, 2021, which is the United States national phase of International Patent Application No. PCT/BR2021/050534 filed Dec. 3, 2021, and claims priority to Brazilian Patent Application No. BR 20 2021 009562 3 filed May 17, 2021, the disclosures of which are hereby incorporated by reference in their entireties.

### BACKGROUND OF THE INVENTION

### Field of the Invention

This invention refers to a sommier box, and more particularly to a box-type bed able to be easily and quickly assembled, even by inexperienced users.

### Description of Related Art

As known in the art, sommier box-type beds, or simply box-type beds, are support structures for a mattress that is arranged above it and, usually, without the presence of edges or side structures partially or completely involving the mattress.

The reduced size of the sommier box, compared to traditional beds equipped with a headboard, counter-headboard and pronounced sides, makes the sommier box particularly suitable for a more agile and simple production, in addition to allowing less bulky and costly transport. A greater rationalization in the logistics of box-type beds can also be obtained by delivering them in disassembled form, which substantially reduces the transported volume, but which entails the need for assembly at the place of delivery/use, usually by a furniture fitter hired by the seller or the manufacturer.

The pinnacle of logistical efficiency, as can be easily inferred, is the possibility that the buyer, even with no experience in assembling furniture and the like, and potentially without basic tools, is able to receive the packed sommier box and can, quickly, easily and without mistakes, assemble it immediately upon receipt of the bed in disassembled condition.

Within this scope, document BR 202018075946-4 illustrates a box-type bed formed by a base defined by the integration of two side spars, a set of central crossbeams, two outer crossbeams, a set of cover slats and a set of support feet. The base of the bed is assembled, or disassembled, by coupling and fixing its components together, specifically by penetrating the ends of the crossbeams into the space defined by the spars, with the final fastening being done using nuts and screws so to integrate the resulting structure. Despite the simplification obtained, the assembly of this box-type bed still requires a certain degree of skill on the part of the furniture fitter, in addition to the use of some tools, even if they are basic.

Document BR 202016002601-1 illustrates a box-type bed for easy assembly or disassembly, wherein three spars having front and rear recesses, in addition to a pair of holes, are provided. The front and rear crossbeams presumably have integrated screws that penetrate the respective holes of the spars and can be screwed in after coupling. After assembling the base frame, the bed frame is extended over it, as it is defined by rigid transverse elements and interconnected by flexible straps. The three spars of the base frame have projections designed to keep the bed frame in its final position. Despite this solution to envisage an easy assembly of the box-type bed, the need to fix the spars with screws on the two crossbeams can lead an inexperienced user to overtighten, or not enough, the nuts on the screw threads, thus compromising the assembly of the box-type bed structure.

An objective of the present invention is therefore a sommier box-type bed able to be locally assembled, or disassembled, without the need for tools, based on a minimum of specific training by the furniture fitter (the very person who bought the bed, for example) and without adjustments.

### SUMMARY OF THE INVENTION

These and other objectives are achieved from a sommier box, comprising a rectangular frame defined by side panels arranged in parallel and interconnected to end panels also arranged in parallel. Said end panels have couplings on the inside and at opposite ends; said side panels also have couplings on the inside and at opposite ends, and the upper face of each side panel has a stepped shape, on the lower plane of which a Velcro strip is fixed; said couplings are defined by plates from which spaced eyelets project, which are able to receive a pin destined to penetrate all the central holes of the eyelets, with such pin being held in position by means of a cotter pin; and bipartite bed frames, each defined by a series of equidistant slats joined by Velcro strips, wherein the position of each Velcro strip corresponds to the position of the respective Velcro strip of said side panels.

Alternatively, and in case of a sommier box-type bed for couples, a central spar is also provided that has, at each of its ends, couplings to fit into respective couplings centrally arranged on each of the end panels, and the upper surface of the center spar is flat, with a Velcro strap attached over it, intended to couple a respective central Velcro strip of the bipartite bed frame.

Alternatively, said end panels, side panels and central spar of the sommier box comprise columns and feet.

### BRIEF DESCRIPTION OF THE DRAWINGS

The terms Fig., Figs., Figure, and Figures are used interchangeably in the specification to refer to the corresponding figures in the drawings.

The object of this invention will be better understood from the detailed description that follows, which is made with the support of the attached illustrative and non-limiting figures, in which:

FIG. 1 is a perspective view of a sommier box-type bed according to the present invention.

FIG. 2 is a perspective view of a single size sommier box-type bed according to the invention.

FIGS. 3A and 3B are views respectively in front elevation and side elevation of the front panel, or the rear panel, of the bed in FIG. 1.

FIGS. 4A and 4B are views respectively in front elevation and side elevation of the side panel;

FIGS. 5A and 5B are views respectively in front elevation and side elevation of the central spar, especially for the sommier boxes in double bed configuration;

FIG. 6 is a perspective view of the bipartite bed frame; and

FIG. 7 is an enlarged image of the connection between any panels.

### DESCRIPTION OF THE INVENTION

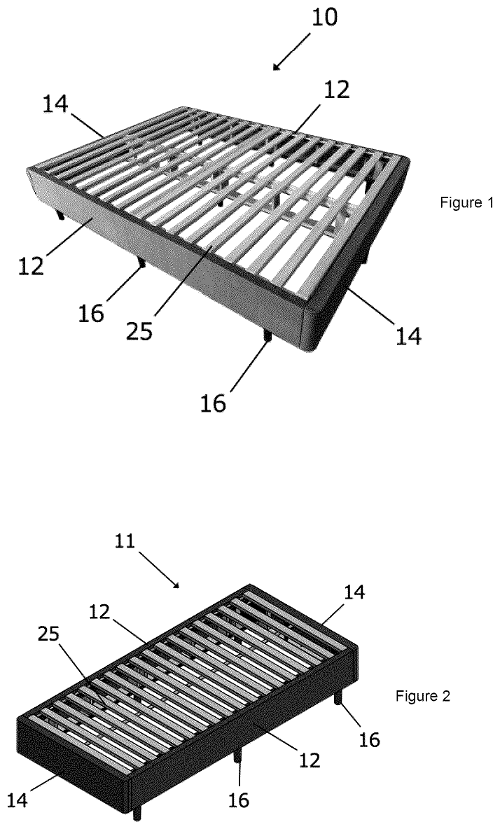

According to FIG. 1, number (10) indicates generally a sommier box in a double bed configuration. FIG. 2 illustrates a sommier box (11) in a single bed configuration. The basic difference between these two embodiments is exclusively limited to the presence of a central spar in the double version, whatever the size adopted (double, king, queen bed, or other).

In any configuration, the sommier box (10, 11) is defined by side panels (14), fixed from their ends to respective end panels (12), headboard or counter-headboard, thus defining a rectangular frame.

Furthermore, said frame is arranged on a plurality of feet (16), which project from respective panels (12, 14). In larger versions of the sommier box (10), the central spar (13) also has feet (16) similar to the mentioned ones.

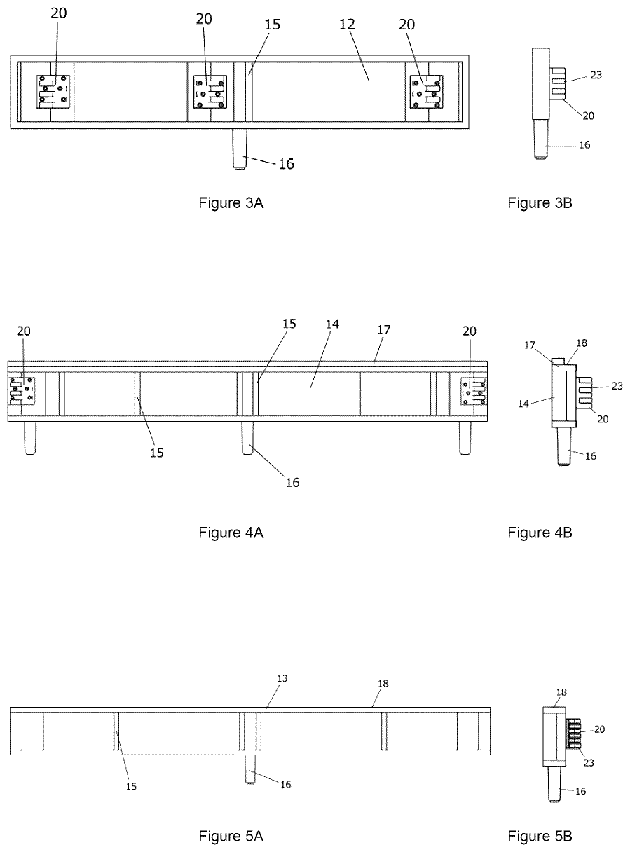

Regarding the sommier box (10, 11) end panels (12)—see FIGS. 3A and 3B—regardless of the headboard or counter-headboard position, they are a rectangular structure, preferably made of wood and externally coated with a finishing element, such as fabric, leather, or otherwise. Eventually, the end panels (12) may have columns (15) for distributing the loads supported by them, especially in case of the sommier box (10).

At the ends of each end panel (12) there is also a coupling (20) (see FIG. 7 specifically), and alternatively a central coupling (20) for the composition panels of the sommier box-type double bed (10), or larger bed sizes. The structure and functionality of these couplings (20) will be explained later.

Regarding the sommier box (10, 11) side panels (14)—see FIGS. 4A and 4B—regardless of their right or left position, they are presented as a rectangular frame, preferably made of wood and externally coated with a finishing element, similar to that of the end panels (12). Each side panel (14) can also have columns (15) to better distribute the load on these structures. On the inside of each panel (14), specifically at its opposite ends, couplings (20) are fixed, which are used for reciprocal connection.

In addition, the upper face of each side panel (14) has a step shape (17) having the lowest plane facing the interior of the sommier box (10, 11). In particular, said lower step (17) has a Velcro (18), which can be stapled, glued or fixed in an appropriate way, able to retain the bipartite bed frame (25).

Regarding said bipartite bed frame (25), it is composed of a series of slats (26) joined by Velcro strips (28), in opposite configuration to the Velcro strips (18) attached to the side panels (14). In other words, if the Velcro strip (28) is a male strip, the Velcro strip (18) will be a female strip, and vice versa. Furthermore, as the Velcro strips are malleable, each of the bipartite bed frames (25) can be easily rolled up for transport, saving storage space.

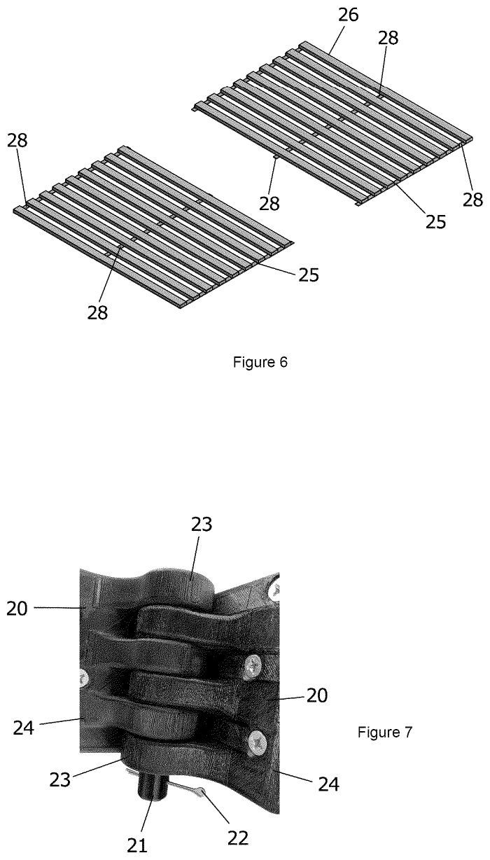

Regarding the sommier box (10) in FIG. 1, that is, having dimensions for two people (double, king or queen bed), a central spar (13) is also provided—see FIGS. 5A and 5B specifically, whose structure is very similar to that of any of the side panels (14), that is, rectangular shape, provided with columns (15) and feet (16), but without having a coated external face, since it is intended to remain in a not visible central position of the box-type bed (10), as shown in FIG. 1. Furthermore, the upper surface of the central spar (13) is a flat surface on which a Velcro strip (18) is fixed, also intended to couple a respective central Velcro strip (28) of the bipartite bed frame. Said central spar (13) also has, at each of its ends, couplings (20) for coupling with each of the end panels (14).

Finally, and in relation to said couplings (20), better illustrated in FIG. 7, each coupling has a general conformation similar to a hinge, that is, composed of plates (24) from which eyelets (23) having equivalent thickness and interlocking protrude. The fastening between two couplings (20) is done by means of a slightly conical pin (21) that penetrates all the central holes of the eyelets (23), and which is safely kept in position by means of a cotter pin (22).

From the description of the elements above, it is possible to see that the assembly method of the sommier box (10, 11) is extremely fast and simple, in addition to dispensing with the use of tools.

In this sense, after unpacking all the component elements of the sommier box (10, 11), they must be arranged close to their final position, proceeding then with the coupling of the various panels (12, 14)-and eventually the central spar (13)-by means of the pin (21) inserted in each pair of couplings (20) pre-positioned and fixed (by penetration and bending) by the cotter pins (22). Once the frame of the box-type bed (10, 11) is assembled, the furniture fitter simply places the two bipartite bed frames (25), making each Velcro strip (28) coincide with the respective Velcro strip (18) of the side panels (12) and, eventually, of the central spar (13). In the tests carried out, the total assembly of the sommier box-type bed (10, 11) takes about 2 minutes, thus proving its simplicity and ease of assembly, without the use of any tools.

What is claimed is:

1. A quick assembly sommier box-type bed, comprising a rectangular frame defined by side panels arranged in parallel and interconnected to end panels also arranged in parallel, wherein:
said end panels have couplings on an inside and at opposite ends;
said side panels have couplings on the inside and at opposite ends, and an upper face of each side panel has a step shape in the lower plane of which it is fixed a Velcro strip; and
said couplings being defined by plates from which eyelets project spaced apart, said eyelets being able to receive a pin intended to penetrate all central holes of the eyelets, such pin being held in position by means of a cotter pin; and
further comprising bipartite bed frames defined by a series of equidistant slats joined by Velcro strips, wherein the position of each Velcro strip corresponds to the position of the respective Velcro strip of said side panels.

2. The quick assembly sommier box-type bed, according to claim 1, wherein a central spar that has, at each of its ends, couplings to fit into respective couplings centrally arranged on each of the end panels, and an upper surface of the center spar is flat, having a Velcro strap attached over it, intended to couple a respective central Velcro strip of the bipartite bed frames.

3. The quick assembly sommier box-type bed, according to claim 1, wherein said end panels, side panels and central spar comprise columns and feet.
